(19) United States
(12) Patent Application Publication
(10) Pub. No.: US 2014/0225819 A1
(43) Pub. Date: Aug. 14, 2014

(54) IMAGE DISPLAY DEVICE AND DRIVING METHOD

(71) Applicant: Japan Display Inc., Minato-ku (JP)

(72) Inventors: Takahiro ONUMA, Tokyo (JP); Kenji Harada, Tokyo (JP); Satoshi Maruyama, Tokyo (JP)

(73) Assignee: Japan Display Inc., Minato-ku (JP)

(21) Appl. No.: 14/171,053

(22) Filed: Feb. 3, 2014

(30) Foreign Application Priority Data
Feb. 8, 2013 (JP) 2013-023216

(51) Int. Cl. G09G 3/36; G09G 3/20

(52) U.S. Cl. CPC G09G 3/3648; G09G 3/2003
USPC 345/88; 345/87

(57) ABSTRACT

Data lines are connected to pixels arranged on both sides of the data lines respectively, a c^{th} gate line and a (c+1)^{th} gate line are connected respectively to pixels arranged between the c^{th} gate line and the (c+1)^{th} gate line alternately, in the case of displaying an image at a N^{th} frame, the first gate line driver circuit and the second gate line driver circuit supply the gate signal to the c^{th} gate line and the (c+1)^{th} gate line in this order, and in the case of displaying an image at a (N+1)^{th} frame, the first gate line driver circuit and the second gate line driver circuit supply the gate signal to the (c+1)^{th} gate line and the c^{th} gate line in this order.

### CROSS-REFERENCE TO RELATED APPLICATIONS

This application is based upon and claims the benefit of priority from the prior Japanese Patent Application No. 2013-23216, filed on Feb. 8, 2013; the entire contents of which are incorporated herein by reference.

### FIELD

Embodiments described herein relate to an image display device and a driving method therefor.

### BACKGROUND

A liquid crystal display device, which is an example of image display devices, includes an image display unit configured to display information and a control unit configured to control the image display unit. The image display unit includes an array substrate and an opposed substrate opposed each other in pair, a liquid crystal layer arranged therebetween, and a plurality of pixels arranged on the array substrate in a matrix pattern (see JP-A-6-148680).

In quest to improve a resolution, the numbers of gate lines and data lines are increased in association with an increase in number of pixels, and an increasing cost burden of ICs has now become a problem. In association with the increase in number of the data lines, power consumption is increased, and securement of an aperture ratio become difficult.

In order to solve this problem, a data-sharing type liquid crystal display device configured to drive two rows of pixels by a single data line to reduce the number of the data lines by half is proposed. With the liquid crystal display device of the type described above, not only a reduction of the cost burden of the ICs described above, a reduction of the width of a frame, and an improvement in yield, but also a reduction in power consumption on the basis of a reduction in number of data lines and an improvement of the aperture ratio are expected.

(1) Configuration of Liquid crystal display device of the Related Art

A data-sharing type liquid crystal display device of the related art will be described with reference to a schematic drawing in FIG. 1.

In this liquid crystal display device, gate lines of TFTs (Thin Film Transistors) for pixels in lateral lines are shared and the data lines are connected to source electrodes of the TFTs for RGB pixels. For example, pixels of three colors, red (R), green (G), and blue (B) are arranged in a matrix pattern, gate electrodes of pixels R11 to B12 are connected to a gate line Gate (1) and pixels R21 to B22 are connected to a gate line Gate (2). The data lines Data (1) to Data (6) for respective colors RGB are connected to the source electrodes of the TFTs in the respective pixels.

### (2) Configuration of Data-Sharing Type Liquid Crystal Display Device of the Related Art

A data-sharing type liquid crystal display device of the related art will be described with reference to a schematic drawing in FIG. 2.

In this liquid crystal display device, two gate lines are connected alternately to TFTs of pixels in the lateral lines, and a data line connected to source electrodes of the TFTs of a plurality of adjacent pixels are shared. In the drawing, pixels in three colors, red (R), green (G), and blue (B), are arranged in a matrix pattern, pixels R11, B11, and G12 are connected to the gate line Gate (1) pixels G11, R12, and B12 are connected to a gate line Gate (2), pixels R21, B21, and G22 are connected to a gate line Gate (3), and pixels G21, R22, and B22 are connected to a gate line Gate (4).

In this liquid crystal display device, the data line may be shared by a plurality of pixels and, in the drawing, the data line Data (1) is connected so as to share the pixels R11, G11, R21, and G21, the data line Data (2) is connected so as to share the pixels B11, R12, B21, and R22 pixels, and the data line Data (3) is connected so as to share the pixels G12, B12, G22, and B22, whereby the number of the data lines are reduced by half the related art.

### (3) Driving Method for Pre-Charged Data-Sharing Type Liquid Crystal Display Device

First of all, a first driving method for a data-sharing type liquid crystal display device with pre-charge of the related art will be described with reference to FIG. 3 and FIG. 4. FIG. 3 illustrates a pixel equivalent circuit, and FIG. 4 is a timing chart.

The pixel equivalent circuit will be described with reference to FIG. 3. The pixel equivalent circuit includes a pixel A and a pixel B, the gate line Gate (1) is connected to a gate electrode of a TFT of the pixel A, the gate line Gate (2) is connected to a gate electrode of a TFT of the pixel B. The data line Data (1) is connected to source electrodes of the pixels A and B and includes a pixel electrode configured to receive a data signal, a counter electrode (shared electrode) on the side opposite to the pixel electrode, a liquid crystal layer 20 between the pixel electrode and the counter electrode, and an accumulated capacity 22.

The driving method for this pixel equivalent circuit will be described with reference to the timing chart in FIG. 4.

First of all, when the gate line Gate (1) becomes a High level (hereinafter, referred to as a H level), the H level is supplied to the gate electrode of the TFT of the pixel A, whereby the source electrode and a drain electrode of the TFT of the pixel A are brought into a conducting state. A positive signal potential of an upstream is applied to the pixel electrode of the pixel A from the data line Data (1) via the source electrode. Then, a negative signal potential is applied to the pixel electrode of the pixel A from the data line Data (1) via the source electrode.

Subsequently, when the gate line Gate (2) becomes the H level, an H level is supplied to the gate electrode of the TFT of the pixel B, whereby the source electrode and a drain electrode of the TFT of the pixel B are brought into the conducting state. The negative signal potential applied to the pixel electrode of the pixel A is applied to the pixel electrode of the pixel B.

Subsequently, when the gate line Gate (1) becomes a Low level (hereinafter, referred to as a L level), the L level is supplied to the gate electrode of the TFT of the pixel A, whereby the source electrode and the drain electrode of the TFT of the pixel A are brought into an insulated state, and the pixel A retains the negative potential. In contrast, a negative signal potential is applied to the pixel electrode of the pixel B, the source electrode and the drain electrode of which are in the conducting state, from the data line Data (1) via the source electrode of pixel B.

Subsequently, when the gate line Gate (2) becomes the L level, the L level is supplied to the gate electrode of the TFT of the pixel B, whereby the source electrode and the drain electrode of the TFT of the pixel B are brought into the insulated state, and the pixel B retains the negative potential.

In this configuration, at the pixel electrode of the pixel A, a data signal having a potential of a polarity opposite to the desired potential is written in a pre-charge period, and then a desired data signal is written in a writing period. In contrast, at the pixel electrode of the pixel B, a data signal having a potential of the same polarity as the desired potential is written in the pre-charge period, and then a desired data signal is written in a writing period. Therefore, the potentials to be written in the pixel electrodes of the pixel A and the pixel B are different, and hence an uneven display may occur in a plane.

### (4) Second Driving Method for Data-Sharing Type Liquid Crystal Display Device Without Pre-Charge

Subsequently, a driving method for the data-sharing type liquid crystal display device without pre-charge of the related art will be described with reference to FIG. 5 and FIG. 6. FIG. 5 is a pixel equivalent circuit, and FIG. 6 is a timing chart. The pixel equivalent circuit in FIG. 5 is a pixel equivalent circuit having the same configuration as that in FIG. 3. Therefore, only the driving method will be described by using the timing chart in FIG. 6.

First of all, when the gate line Gate (1) becomes the H level, the H level is supplied to the gate electrode of the TFT of the pixel A, whereby the source electrode and the drain electrode of the TFT of the pixel A are brought into the conducting state. The negative signal potential is applied to the pixel electrode of the pixel A from the data line Data (1) via the source electrode.

At that time, when the gate line Gate (1) becomes the L level, the L level is supplied to the gate electrode of the TFT of the pixel A, whereby the source electrode and the drain electrode of the TFT of the pixel A are brought into the insulated state, and the pixel A retains the negative potential.

Subsequently, when the gate line Gate (2) becomes the H level, the H level is supplied to the gate electrode of the TFT of the pixel B, whereby the source electrode and the drain electrode of the TFT of the pixel B are brought into the conducting state. The negative signal potential is applied to the pixel electrode of the pixel B from the data line Data (1) via the source electrode of pixel B.

At that time, when the gate line Gate (2) becomes the L level, the L level is supplied to the gate electrode of the TFT of the pixel B, whereby the source electrode and the drain electrode of the TFT of the pixel B are brought into the insulated state, and the pixel B retains the negative potential.

In this configuration, the data signals is written in the pixel electrode of the pixel A and the pixel electrode of the pixel B only during the writing period, and hence the both pixels are in a state against charging. Therefore, even though the display quality such as an uneven display is eliminated, all the pixels may be brought into the state against charging, and hence lowering of luminance may result.

In this configuration, the driving method for the data-sharing type liquid crystal display device with pre-charge has no ability to temporary average the luminance difference caused by a difference in charged state, so that impairment of the display quality such as the uneven display may occur.

In the case of the driving method for the data-sharing type liquid crystal display device without pre-charge, all the pixels are brought into the state against charging in order to eliminate the luminance difference, so that lowering of luminance may occur.

In order to solve the above-described problems, it is an object of the invention to provide an image display device and a driving method therefor in which uneven display or lowering of luminance do not occur.

### BRIEF DESCRIPTION OF THE DRAWINGS

FIG. 1 is a schematic drawing of an image display unit of the related art;

FIG. 2 is a schematic drawing of a data-sharing type image display unit of the related art;

FIG. 3 is a pixel equivalent circuit diagram with pre-charge of the related art;

FIG. 4 is a timing chart with pre-charge of the related art;

FIG. 5 is a pixel equivalent circuit diagram without pre-charge of the related art;

FIG. 6 is a timing chart without pre-charge of the related art;

FIG. 7 is a block diagram illustrating an image display unit of Embodiment 1;

FIG. 8 is a pixel equivalent circuit diagram of Embodiment 1;

FIG. 9 is a circuit diagram of the image display unit of Embodiment 1;

FIG. 10 is a timing chart of a gate line at an N^{th} frame;

FIG. 11 is a timing chart of the gate line at an (N+1)^{th} frame;

FIG. 12 is a timing chart at the N^{th} frame;

FIG. 13 is a timing chart at the (N+1)^{th} frame;

FIG. 14 is a diagram illustrating a pixel charged state at the N^{th} frame of Embodiment 2;

FIG. 15 is a timing chart at the N^{th} frame of Embodiment 2;

FIG. 16 is a diagram illustrating a pixel charged state at the (N+1)^{th} frame of Embodiment 2;

FIG. 17 is a timing chart at the (N+1)^{th} frame of Embodiment 2;

FIG. 18 is a diagram illustrating a pixel charged state at the N^{th} frame of Embodiment 3;

FIG. 19 is a timing chart at the N^{th} frame of Embodiment 3;

FIG. 20 is a diagram illustrating a pixel charged state at the (N+1)^{th} frame of Embodiment 3;

FIG. 21 is a timing chart at the (N+1)^{th} frame of Embodiment 3;

FIG. 22 is a diagram illustrating a pixel charged state at the N^{th} frame of Embodiment 4;

FIG. 23 is a timing chart at the N^{th} frame of Embodiment 4;

FIG. 24 is a diagram illustrating a pixel charged state at the (N+1)^{th} frame of Embodiment 4;

FIG. 25 is a timing chart at the (N+1)^{th} frame of Embodiment 4;

FIG. 26 is a schematic drawing of a Pentile and a data-sharing type image display unit of Embodiment 5;

FIG. 27 is a diagram illustrating a pixel charged state at the N^{th} frame of Embodiment 5;

FIG. 28 is a timing chart at the N^{th} frame of Embodiment 6;

FIG. 29 is a diagram illustrating a pixel charged state at the (N+1)^{th} frame of Embodiment 6;

FIG. 30 is a timing chart at the (N+1)^{th} frame of Embodiment 6;

FIG. 31 is a diagram illustrating a pixel charged state at the N^{th} frame of Embodiment 7;

FIG. 32 is a timing chart at the N^{th} frame of Embodiment 7;

FIG. 33 is a diagram illustrating a pixel charged state at the (N+1)^{th} frame of Embodiment 7;

FIG. 34 is a timing chart at the (N+1)^{th} frame of Embodiment 7;

FIG. 35 is a diagram illustrating a pixel charged state at the N^{th} frame of Embodiment 8;

FIG. 36 is a timing chart at the N^{th} frame of Embodiment 8;

FIG. 37 is a diagram illustrating a pixel charged state at the (N+1)^{th} frame of Embodiment 8; and

FIG. 38 is a timing chart at the (N+1)^{th} frame of Embodiment 8.

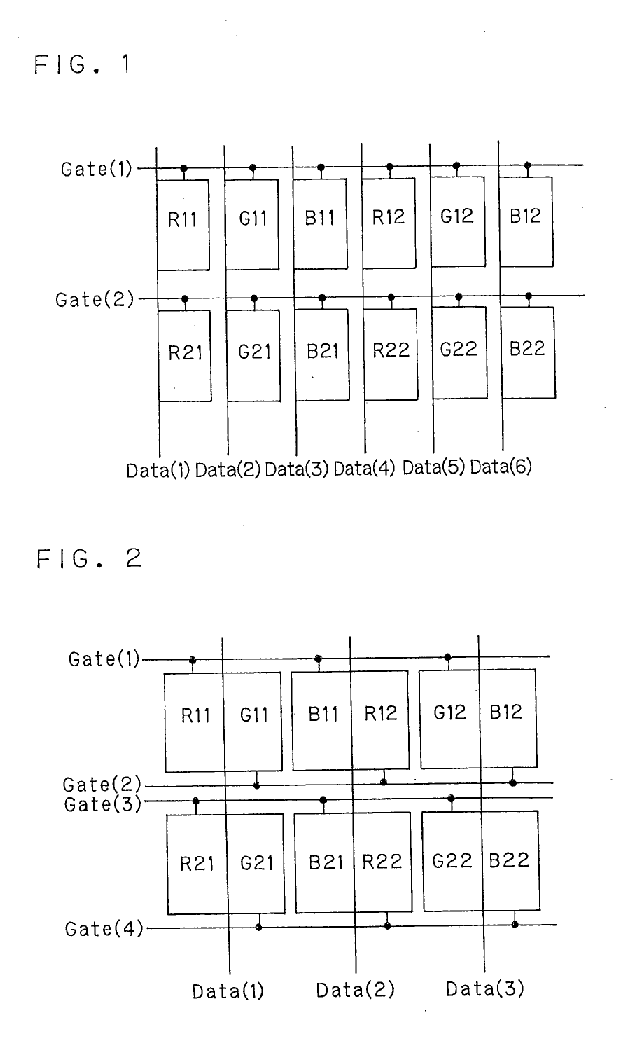

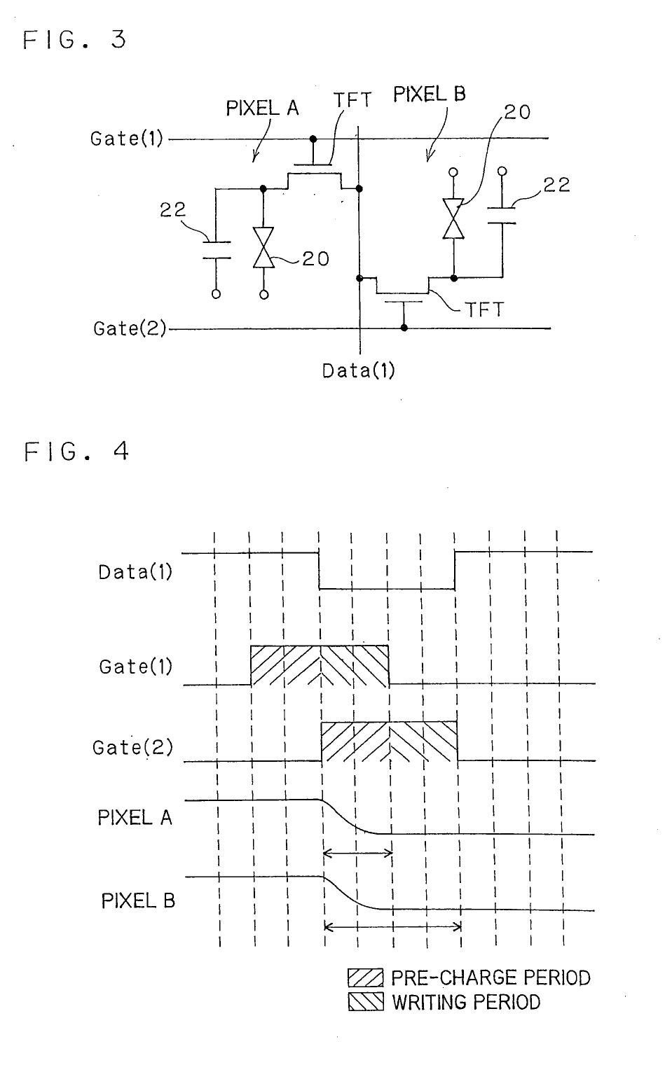

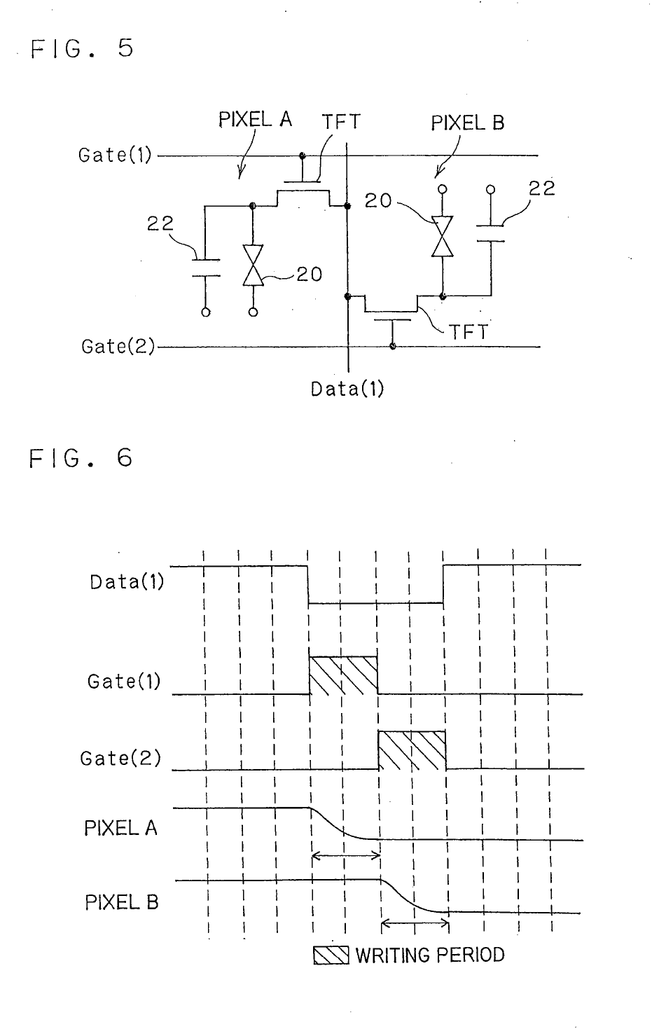

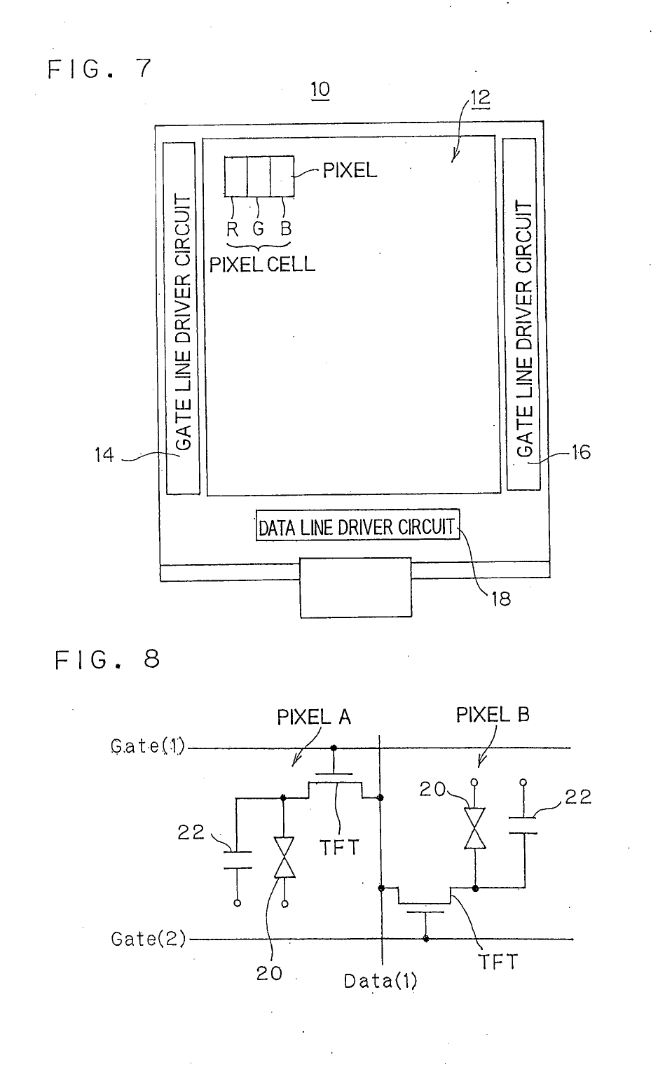

### DETAILED DESCRIPTION

According to embodiments, there is provided an image display device including: an image display unit on which (C×2D) pixels are arrayed in a matrix pattern; D data lines configured to supply data signals to the pixels; 2C gate lines arranged so as to intersect the data lines and configured to supply gate signals to the pixels; a data line driver circuit configured to supply data signals to the data lines; a first gate line driver circuit configured to supply gate signals to a c^{th} gate line (where c is an odd number and a relation 1 c<2C−1 is satisfied); and a second gate line driver circuit configured to supply gate signals to a (c+1)^{th} gate line, wherein the data lines are connected to the pixels arranged on both sides of the data lines respectively, the c^{th} gate line and the (c+1)^{th} gate line are connected respectively to the pixels arrayed between the c^{th} gate line and the (c+1)^{th} gate line alternately, and the first gate line driver circuit and the second gate line driver circuit (1) supplies the gate signals to the c^{th} gate line and the (c+1)^{th} gate line in this order when displaying an image at the N^{th} frame (N≧1), and (2) supplies the gate signals to the (c+1)^{th} frame and the c^{th} gate line in this order when displaying an image at a (N+1)^{th} frame.

According to embodiments, there is also provided an image display device including: an image display unit on which (C×2D) pixels are arrayed in a matrix pattern; a D data lines configured to supply data signals to the pixels; 2C gate lines arranged so as to intersect the data lines and configured to supply gate signals to the pixels; data line driver circuit configured to supply data signals to the data lines; a first gate line driver circuit configured to supply gate signals to the c^{th} gate line (where c is an odd number and a relation 1≦c<2C−1 is satisfied); a second gate line driver circuit configured to supply gate signals to (c+1)^{th} gate lines; and a main control unit, wherein the data lines are connected to the pixels arranged on both sides of the data lines respectively, the c^{th} gate line and the (c+1)^{th} gate line are connected respectively to the pixels arrayed between the c^{th} gate line and the (c+1)^{th} gate line alternately, the first gate line driver circuit and the second gate line driver circuit (1) supplies the gate signals to the c^{th} gate line and the (c+1)^{th} gate line in this order when displaying an image at the N^{th} frame (where N≧1), (2) supplies the gate signals to the (c+1)^{th} frame and the c^{th} gate line in this order when displaying an image at the (N+1)^{th} frame, and the main control unit supplies the start pulses to the first gate line driver circuit and the second gate line driver circuit in this order when displaying the image at the N^{th} frame, and supplies start pulses to the second gate line driver circuit and the first gate line driver circuit in this order when displaying the image at the (N+1)^{th} frame.

### Embodiment 1

Referring now to FIG. 7 to FIG. 13, a liquid crystal display device 10 of Embodiment 1 will be described. With Embodiment 1, a case where a data-sharing type liquid crystal display device 10 performs a gate line multi drive will be described.

### (1) Configuration of Liquid Crystal Device 10

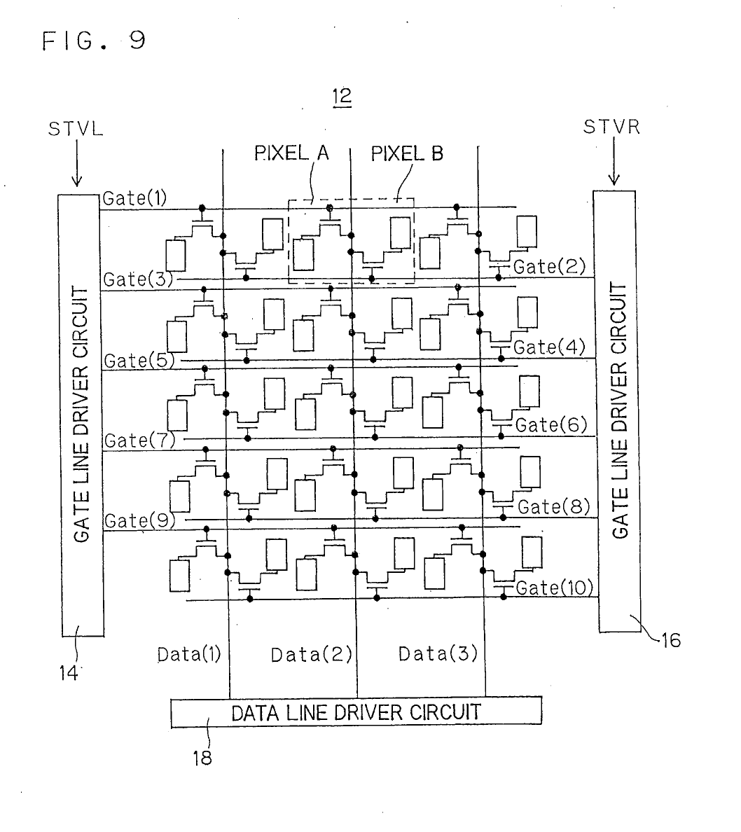

A configuration of the liquid crystal display device 10 of Embodiment 1 will be described with reference to FIG. 7 to FIG. 9. FIG. 7 is a block diagram illustrating an image display unit 12. FIG. 8 illustrates a pixel equivalent circuit of the image display unit 12. FIG. 9 is a circuit diagram of the image display unit 12.

As illustrated in FIG. 7, the liquid crystal display device 10 includes the image display unit 12, a first gate line driver circuit 14, a second gate line driver circuit 16, and a data line driver circuit 18. The image display unit 12 includes an array substrate, an opposed substrate, and a liquid crystal layer 20 sandwiched between the array substrate and the opposed substrate. The array substrate and the opposed substrate are a pair of transparent insulated substrates arranged so as to oppose each other. The array substrate includes a plurality of pixels PX arranged in a matrix pattern. A counter electrode is provided on the opposed substrate and a counter potential is applied thereto.

As illustrated in FIG. 9, the image display unit 12 includes C×2D pixels arranged in a matrix pattern including red (R), green (G), and blue (B) pixels, and these pixels in three colors constitute one pixel cell. 2C gate lines Gate (1) to Gate (2C) and D data lines Data (1) to Data (D) intersecting each other are connected to each of the pixels.

As illustrated in FIG. 9, the first gate line driver circuit 14 is arranged on the left side of the image display unit 12, and supplies gate signals to the respective pixels by using odd-number^{th} gate lines Gate (c) (where c is an odd number, and 1=≦c≦2C−1), and the second gate line driver circuit 16 is arranged on the right side of the image display unit 12, and supplies gate signals to the respective pixels by using even-number^{th} gate lines Gate (c+1). The data line driver circuit 18 supplies data signals to the respective pixels by using the data lines. A main control unit (which is not illustrated) provided on the exterior outputs a start pulse for driving the gate lines Gate (1) to Gate (2C).

As illustrated in FIG. 9, the data lines Data (1) to Data (D) extending from the data line driver circuit 18 intersect the gate lines, and two rows of the pixel cells on both sides are connected to one data line. Therefore, the number of the data lines is D, which is half the number of rows of pixels 2D.

As illustrated in FIG. 8, the pixel equivalent circuit includes a pixel A and a pixel B, the gate line Gate (1) is connected to a gate electrode of a TFT (Thin Film Transistor) of the pixel A, the gate line Gate (2) is connected to a gate electrode of a TFT of the pixel B. The data line Data (1) is connected to source electrodes of the TFTs of the respective pixels A and B. Each pixel includes a pixel electrode configured to receive a data signal, a counter electrode (shared electrode) on the side opposite to the pixel electrode, a liquid crystal layer 20 between the pixel electrode and the counter electrode, and an accumulated capacity 22.

### (2) Gate Line Multi-Drive

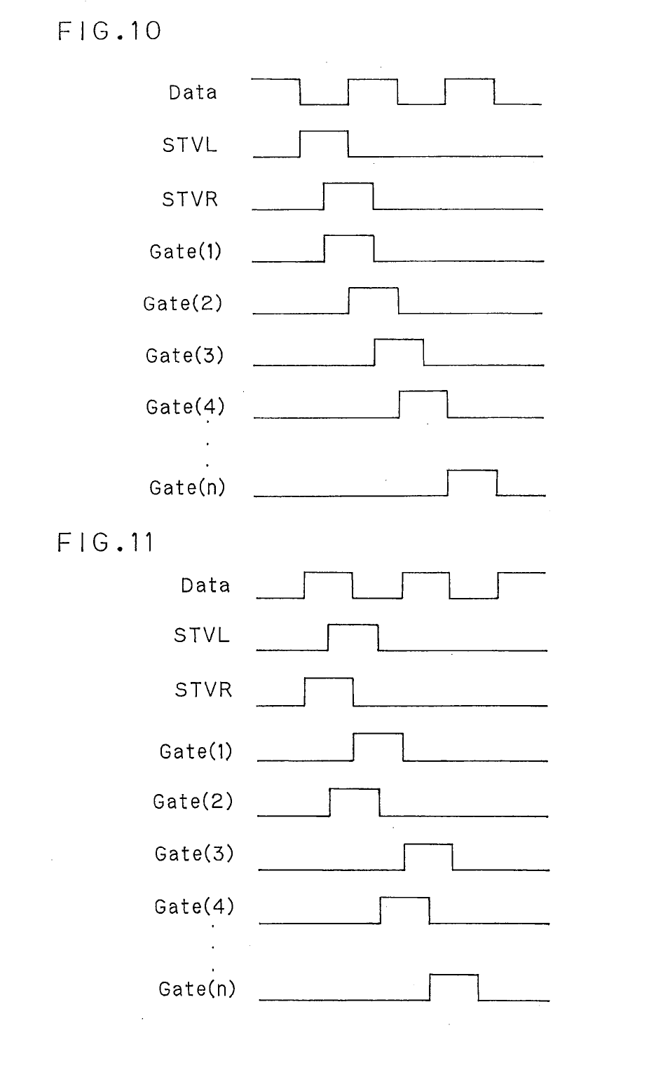

Gate line multi-drive of the liquid crystal display device 10 will be described with reference to FIG. 10 to FIG. 13. The term “gate line multi-drive” means a method of changing the scanning order of the gate lines from frame to frame. In Embodiment 1, the scanning order of the gate lines is changed by changing the start pulses of the gate line driver circuits provided on the left and the right.

FIG. 10 and FIG. 11 are timing charts illustrating the gate line multi-drive of Embodiment 1. FIG. 10 illustrates a timing chart of a gate line at an N^{th} frame, and FIG. 11 is a timing chart of a gate line at an (N+1)^{th} frame. The term “Data” indicates the data signal, the term “STVL” indicates a start pulse supplied from the main control unit to the first gate line driver circuit 14, and the term “STVR” indicates a start pulse supplied from the main control unit to the second gate line driver circuit 16.

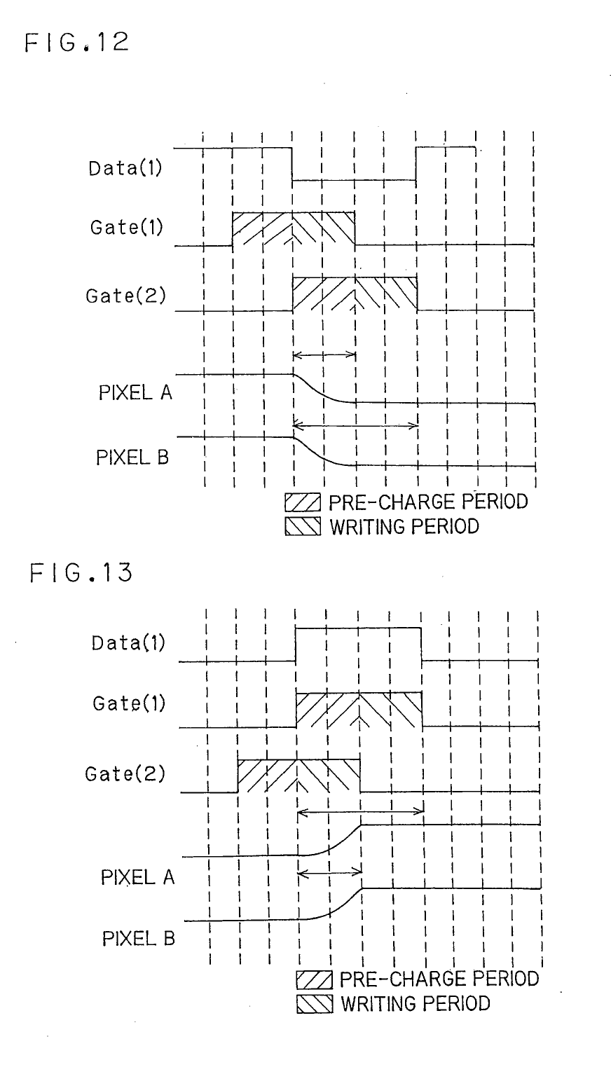

FIG. 12 and FIG. 13 are timing charts of the data signal Data and the gate line Gate (1) to the gate line Gate (2) and, in Embodiment 1, the scanning of the gate lines is changed from frame to frame. FIG. 12 is a timing chart at the N^{th} frame (provided that N>=1), and FIG. 13 is a timing chart at the time of (N+1)^{th} frame.

### (3) Drive Method at N^{th} Frame

The gate line multi-drive at the N^{th} frame will be described on the basis of FIG. 12.

First of all, when the gate line Gate (1) becomes the H level, the H level is supplied to the gate electrode of the TFT of the pixel A, whereby the source electrode and the drain electrode of the TFT of the pixel A are brought into the conducting state. A positive signal potential of a previous stage is supplied to the pixel electrode of the pixel A from the data line Data (1) via the source electrode. Then, a negative signal potential is applied to the pixel electrode of the pixel A from the data line Data (1) via the source electrode.

Subsequently, when the gate line Gate (2) becomes the H level, the H level is supplied to the gate electrode of the TFT of the pixel B, whereby the source electrode and the drain electrode of the TFT of the pixel B are brought into the conducting state. The negative signal potential applied to the pixel electrode of the pixel A is applied to the pixel electrode of the pixel B.

Subsequently, when the gate line Gate (1) becomes the L level, the L level is supplied to the gate electrode of the TFT of the pixel A, whereby the source electrode and the drain electrode of the TFT of the pixel A are brought into the insulated state, and the pixel A retains the negative potential. In contrast, the negative signal potential is applied to the pixel B, the source electrode and the drain electrode of which are in the conducting state from the data line Data (1).

Subsequently, when the gate line Gate (2) becomes the L level, the L level is supplied to the gate electrode of the TFT of the pixel B, whereby the source electrode and the drain electrode of the TFT of the pixel B are brought into the insulated state, and the pixel B retains the negative potential.

In this configuration, at the pixel electrode of the pixel A illustrated in FIG. 8, a data signal having a potential of a polarity opposite to the desired potential is written in a pre-charge period, and then the desired data signal is written in a writing period at the N^{th} frame of FIG. 12. In contrast, at the pixel electrode of the pixel B, the data signal having a potential of the same polarity as the desired potential is written in the pre-charge period, and then the desired data signal is written in the writing period.

Therefore, at the N^{th} frame, the pixel A illustrated in FIG. 8 is in the state against charging in comparison with the pixel B.

### (4) Drive Method at (N+1)^{th} Frame

The gate line multi-drive at the (N+1)^{th} frame will be described on the basis of FIG. 13.

First of All, when the gate line Gate (2) becomes the H level, the H level is supplied to the gate electrode of the TFT of the pixel B, whereby the source electrode and the drain electrode of the TFT of the pixel B are brought into the conducting state. A negative signal potential of a previous stage is supplied to the pixel electrode of the pixel B from the data line Data (1) via the source electrode. Then, a positive signal potential is applied to the pixel electrode of the pixel B from the data line Data (1) via the source electrode.

Subsequently, when the gate line Gate (1) becomes the H level, the H level is supplied to the gate electrode of the TFT of the pixel A, whereby the source electrode and the drain electrode of the TFT of the pixel A are brought into the conducting state. A positive signal potential applied to the pixel electrode of the pixel A is applied to the pixel electrode of the pixel B.

Subsequently, when the gate line Gate (2) becomes the L level, the L level is supplied to the gate electrode of the TFT of the pixel B, whereby the source electrode and the drain electrode of the TFT of the pixel B are brought into the insulated state, and the pixel B retains the positive potential. In contrast, a positive signal potential is applied to the pixel A, the source electrode and the drain electrode of which are in the conducting state from the data line Data (1).

Subsequently, when the gate line Gate (1) becomes the L level, the L level is supplied to the gate electrode of the TFT of the pixel A, whereby the source electrode and the drain electrode of the TFT of the pixel A are brought into the insulated state, and the pixel A retains the positive potential.

In this configuration, at the pixel electrode of the pixel B illustrated in FIG. 8, a data signal having a potential of a polarity opposite to the desired potential is written in the pre-charge period, and then the desired data signal is written in the writing period at the (N+1)^{th} frame of FIG. 13. In contrast, at the pixel electrode of the pixel A, the data signal having the same polarity as the desired potential is written in the pre-charge period, and then the desired data signal is written in the writing period.

Therefore, at the (N+1)^{th} frame, the pixel B is in the state against charging in comparison with the pixel A.

### (5) Advantages

According to Embodiment 1, by performing a writing correction to the pixel electrode by using two frames (if charging is not enough at the previous frame, correction to achieve full charge is performed at the next frame), the luminance difference caused by the charge difference between the pixel A and pixel B is averaged temporarily and spatially, so that the image display is achieved without impairing the display quality.

In the related art, when wiring of an In-Cell touch panel or the like is performed, there are a requirement of wiring on a separate layer and a probability of a reduction of an aperture ratio. However, with the data sharing configuration, the number of data lines may be reduced, and hence the wiring on a separate layer for the touch panel is not required, and the reduction of the aperture ratio is reduced.

### Embodiment 2

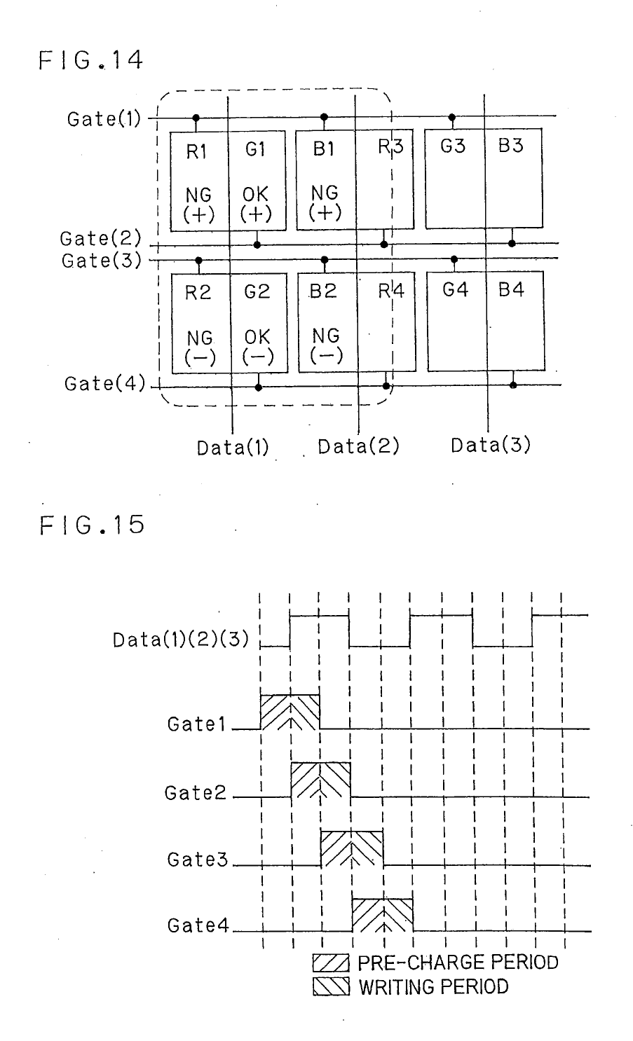

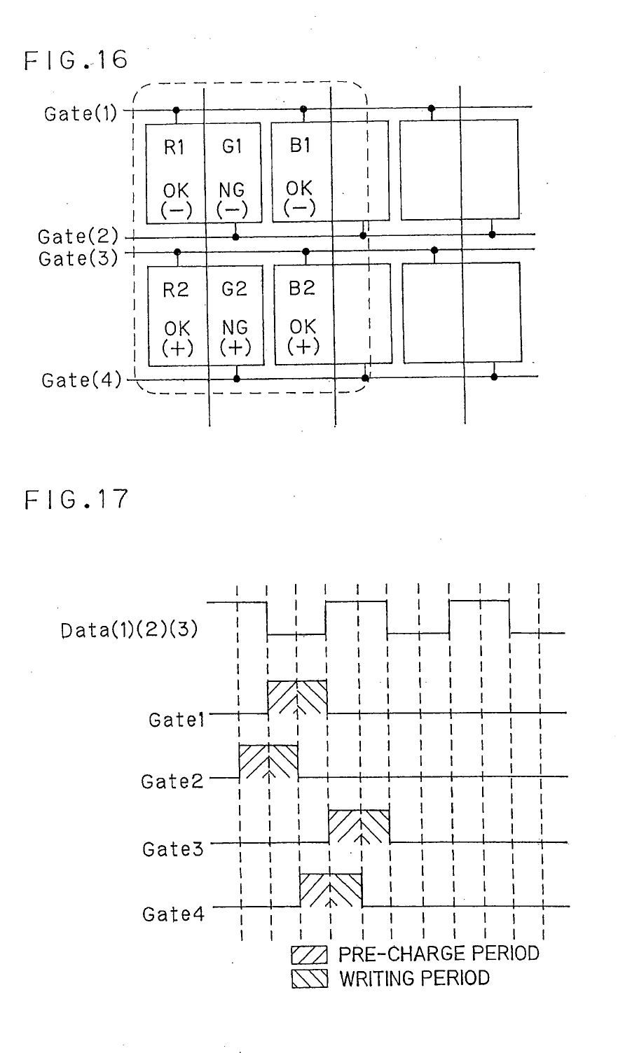

Referring now to FIG. 14 to FIG. 17, the liquid crystal display device 10 of Embodiment 2 will be described. With Embodiment 2, the gate line multi drive is performed by an H-line inversion drive method of the data-sharing type liquid crystal display device 10 will be described. FIG. 14 illustrates a state of charging the pixels at the N^{th} frame, FIG. 15 illustrates a timing chart, FIG. 16 illustrates a state of charging the pixels at the (N+1)^{th} frame, and FIG. 17 illustrates a timing chart.

### (1) Configuration of Pixel Cell

A configuration of a pixel cell of the liquid crystal display device 10 of Embodiment 2 will be described on the basis of FIG. 14 and FIG. 16.

The Pixel cells surrounded by a dot line in FIG. 14 and FIG. 16 is focused.

The gate lines Gate (1), Gate (2), Gate (3), and Gate (4) are connected to each of the gate electrodes of the TFTs of the respective pixels. In the drawings, the gate electrodes of the TFTs of pixels R1 and B1 are connected to the gate line Gate (1), the gate electrode of the TFT of a pixel G1 is connected to the gate line Gate (2), the gate electrodes of the TFTs of pixels R2 and B2 are connected to the gate line Gate (3), and the gate electrode of the TFT of the pixel G2 is connected to the gate line Gate (4).

The data line Data (1) is connected to the pixels R1, G1, R2, and G2, and the data line Data (2) is connected to the pixels B1 and B2.

### (2) Drive Method at N^{th} Frame

Referring now to the timing chart in FIG. 15, the drive method of Embodiment 2 at the N^{th} frame will be described.

First of All, when the gate line Gate (1) becomes the H level, the H level is supplied to the gate electrodes of the TFTs of the pixels R1 and B1, whereby the source electrodes and the drain electrodes of the TFTs of the pixels R1 and B1 are brought into the conducting state. Negative signal potentials are supplied to the pixel electrodes of the pixels R1 and B1 from the data lines Data (1) and Data (2) via the source electrodes. Then, the positive signal potentials are applied to the pixel electrodes of the pixels R1 and B1 from the data line Data (1) via the source electrode.

Subsequently, when the gate line Gate (2) becomes the H level, the H level is supplied to the gate electrode of the TFT of the pixel G1, whereby the source electrode and the drain electrode of the TFT of the pixel G1 is brought into the conducting state, and a positive signal potential applied to the pixel electrodes of the pixels R1 and B1 are applied to the pixel electrode of the pixel G1.

Subsequently, when the gate line Gate (1) becomes the L level, the L level is supplied to the gate electrodes of the TFTs of the pixels R1 and B1, whereby the source electrodes and the drain electrodes of the TFTs of the pixels R1 and B1 are brought into the insulated state, and the pixels R1 and B1 retain the positive potentials. In contrast, a positive signal potential is applied to the pixel G1, the source electrode and the drain electrode of which are in the conducting state from the data line Data (1).

Subsequently, when the gate line Gate (2) becomes the L level, the L level is supplied to the gate electrode of the TFT of the pixel G1, whereby the source electrode and the drain electrode of the TFT of the pixel G1 are brought into the insulated state, and the pixel G1 retains the positive potential.

Subsequently, when the gate line Gate (3) becomes the H level, the H level is supplied to the gate electrodes of the TFTs of the pixels R2 and B2, whereby the source electrodes and the drain electrodes of the TFTs of the pixels R2 and B2 are brought into the conducting state. Positive signal potentials of a previous stage are supplied to the pixel electrodes of the pixels R2 and B2 from the data lines Data (1) and Data (2) via the source electrodes. Then, a negative signal potential is applied to the pixel electrodes of the pixels R2 and B2 from the data lines Data (1) and Data (2) via the source electrodes.

Subsequently, when the gate line Gate (4) becomes the H level, the H level is supplied to the gate electrode of the TFT of the pixel G2, whereby the source electrode and the drain electrode of the TFT of the pixel G2 are brought into the conducting state. Negative signal potentials applied to the pixel electrodes of the pixels R2 and B2 are applied to the pixel electrode of the pixel G2.

Subsequently, when the gate line Gate (3) becomes the L level, the L level is supplied to the gate electrodes of the TFTs of the pixels R2 an B2, whereby the source electrodes and the drain electrodes of the TFTs of the pixels R2 and B2 are brought into the insulated state, and the pixels R2 and B2 retain the negative potentials. In contrast, a negative signal potential is applied to the pixel G2, the source electrode and the drain electrode of which are in the conducting state from the data line Data (1).

Subsequently, when the gate line Gate (4) becomes the L level, the L level is supplied to the gate electrode of the TFT of the pixel G2, whereby the source electrode and the drain electrode of the TFT of the pixel G2 are brought into the insulated state, and the pixel G2 retains the negative potential.

In this configuration, at the pixel electrodes of the pixels R1 and B1, a data signal having a potential of a polarity opposite to the desired potential is written in the pre-charge period, and then the desired data signal is written in the writing period at the N^{th} frame illustrated in FIG. 14 (in the drawing, it is expressed as “NG”). In contrast, at the pixel electrode of the pixel G1, the data signal having the same polarity as the desired potential is written in the pre-charge period, and then the desired data signal is written in the writing period (in the drawing, it is expressed as “OK”).

In the same manner, at the pixel electrodes of the pixels R2 and B2, a data signal having a potential of a polarity opposite to the desired potential is written in the pre-charge period, and then the desired data signal is written in the writing period illustrated in FIG. 14 (in the drawing, it is expressed as “NG”). In contrast, at the pixel electrode of the pixel G2, the data signal having the same polarity as the desired potential is written in the pre-charge period, and then the desired data signal is written in the writing period (in the drawing, it is expressed as “OK”).

Therefore, pixels against charging at the N^{th} frame are pixels R1, B1, R2, and B2.

### (3) Drive Method at (N+1)^{th} Frame

Referring now to the timing chart in FIG. 17, the drive method of Embodiment 2 at the (N+1)^{th} frame will be described.

First of all, when the gate line Gate (2) becomes the H level, the H level is supplied to the gate electrode of the TFT of the pixel G1, whereby the source electrode and the drain electrode of the TFT of the pixel G1 are brought into the conducting state. A positive signal potential of a previous stage is supplied to the pixel electrode of the pixel G1 from the data line Data (1) via the source electrode. Then, a negative signal potential is applied to the pixel electrode of the pixel G1 from the data line Data (1) via the source electrode.

Subsequently, when the gate line Gate (1) becomes the H level, the H level is supplied to the gate electrodes of the TFTs of the pixels R1 and B1, whereby the source electrodes and the drain electrodes of the TFTs of the pixels R1 and B1 are brought into the conducting state, and the positive signal potential applied to the pixel electrode of the pixel G1 is applied to the pixel electrodes of the pixels R1 and B1.

Subsequently, when the gate line Gate (2) becomes the L level, the L level is supplied to the gate electrode of the TFT of the pixel G1, whereby the source electrode and the drain electrode of the TFT of the pixel G1 are brought into the insulated state, and the pixel G1 retains the negative potential. In contrast, negative signal potentials are applied to the pixels R1 and B1, the source electrodes and the drain electrodes of which are in the conducting state, from the data lines Data (1) and Data (2).

Subsequently, when the gate line Gate (1) becomes the L level, the L level is supplied to the gate electrodes of the TFTs of the pixels R1 and B1, whereby the source electrodes and the drain electrodes of the TFTs of the pixels R1 and B1 are brought into the insulated state, and the pixels R1 and B1 retain the negative potentials.

Subsequently, when the gate line Gate (4) becomes the H level, the H level is supplied to the gate electrode of the TFT of the pixel G2, whereby the source electrode and the drain electrode of the TFT of the pixel G2 are brought into the conducting state. A negative signal potential of a previous stage is supplied to the pixel electrode of the pixel G2 from the data line Data (1) via the source electrode. Then, a positive signal potential is applied to the pixel electrode of the pixel G2 from the data line Data (1) via the source electrode.

Subsequently, when the gate line Gate (3) becomes the H level, the H level is supplied to the gate electrodes of the TFTs of the pixels R2 and B2, whereby the source electrodes and the drain electrodes of the TFTs of the pixels R2 and B2 are brought into the conducting state, and the positive signal potential applied to the pixel electrode of the pixel G2 is applied to the pixel electrodes of the pixels R2 and B2.

Subsequently, when the gate line Gate (4) becomes the L level, the L level is supplied to the gate electrode of the TFT of the pixel G2, whereby the source electrode and the drain electrode of the TFT of the pixel G2 are brought into the insulated state, and the pixel G2 retains the positive potential. In contrast, positive signal potentials are applied to the pixels R2 and B2, the source electrodes and the drain electrodes of which are in the conducting state, from the data lines Data (1) and Data (2). When the gate line Gate (3) becomes the L level, the L level is supplied to the gate electrodes of the TFTs of the pixels R2 and B2, whereby the source electrodes and the drain electrodes of the TFTs of the pixels R2 and B2 are brought into the insulated state, and the pixels R2 and B2 retain the positive potentials.

In this configuration, at the pixel electrode of the pixel G1, a data signal having a potential of a polarity opposite to the desired potential is written in the pre-charge period, and then a desired data signal is written in the writing period at the (N+1)^{th} frame illustrated in FIG. 16 (in the drawing, it is expressed as “NG”). In contrast, at the pixel electrodes of the pixels R1 and B1, a data signal having the same polarity as the desired potential is written in the pre-charge period, and then a desired data signal is written in the writing period (in the drawing, it is expressed as “OK”).

In the same manner, at the pixel electrode of the pixel G2, a data signal having a potential of a polarity opposite to the desired potential is written in the pre-charge period, and then a desired data signal is written in the writing period illustrated in FIG. 16 (in the drawing, it is expressed as “NG”). In contrast, at the pixel electrodes of the pixels R2 and B2, a data signal having the same polarity as the desired potential is written in the pre-charge period, and then a desired data signal is written in the writing period (in the drawing, it is expressed as “OK”).

Therefore, the pixels against charging (NG pixels) at the (N+1)^{th} frame are the pixels G1 and G2.

### (4) Advantages

According to Embodiment 2, by performing a writing correction to the pixel electrode by using two frames (if charging is not enough at the previous frame, correction to achieve full charge is performed at the next frame), the luminance difference caused by the charge difference between the respective pixels is averaged temporarily and spatially, so that the image display is achieved without impairing the display quality.

In the related art, when wiring of the In-Cell touch panel or the like is performed, there are a requirement of wiring on a separate layer and a probability of a reduction of the aperture ratio. However, with the configuration of the data-sharing type, the number of the data lines can be reduced. Therefore, it is not necessary to perform wiring on a separate layer for wiring of the touch panel, and a reduction of the aperture ratio is reduced.

### Embodiment 3

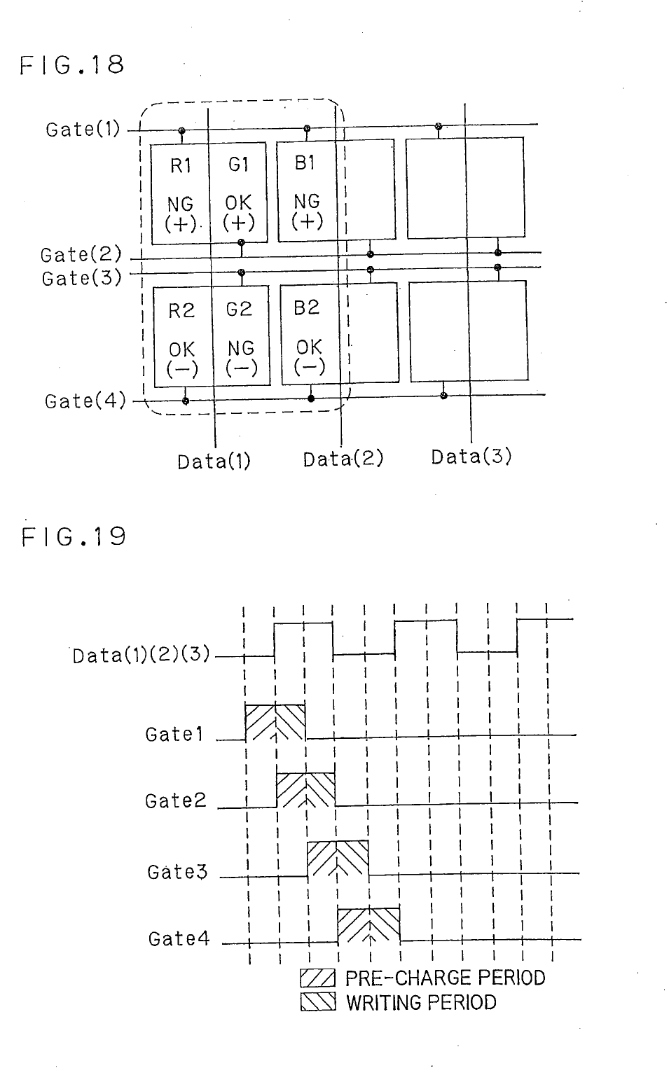

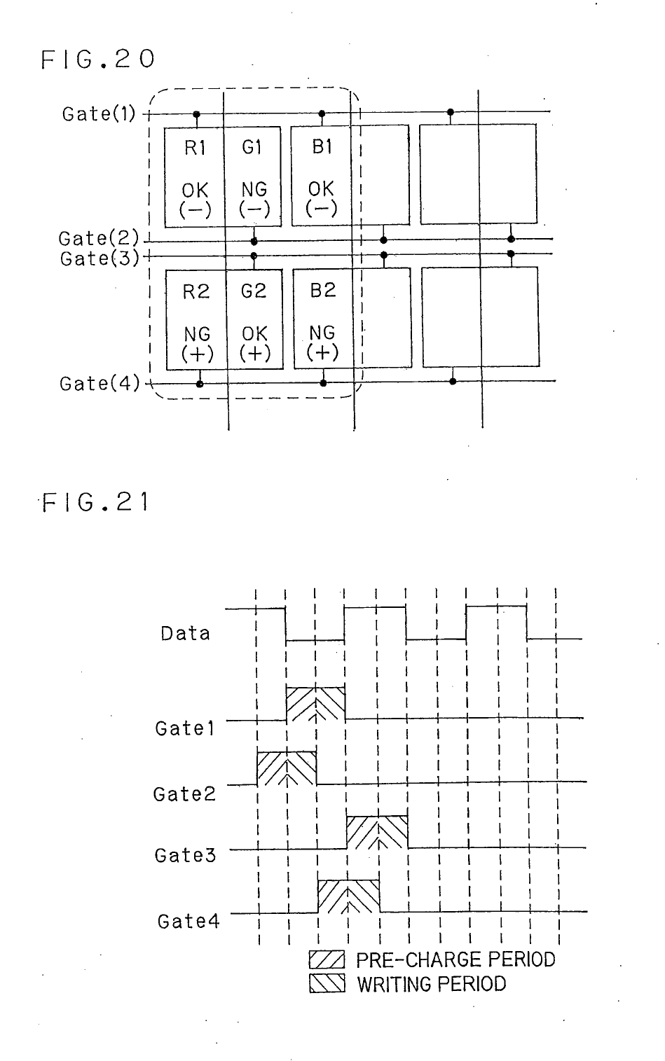

Referring now to FIG. 18 to FIG. 21, the liquid crystal display device 10 of Embodiment 3 will be described. With Embodiment 3, the gate line multi drive and a gate line connection change are performed by the H-line inversion drive method of the data-sharing type liquid crystal display device 10 will be described. FIG. 18 illustrates a state of charging the pixels of the pixel cell at the N^{th} frame, FIG. 19 illustrates a timing chart, FIG. 20 illustrates a state of charging the pixels of the pixel cell at the (N+1)^{th} frame, and FIG. 21 illustrates a timing chart.

The gate line multi-drive may average the luminance difference caused by the charging difference between the pixels temporarily and spatially. However, when viewing the same frame, the pixels against charging and the pixels which are not against charging are arranged row by row alternately. Therefore in Embodiment 3, the pixels against charging and the pixels which are not against charging are dispersed uniformly in a plane by changing a connecting method of the gate lines.

### (1) Configuration of Pixel Cell

A configuration of a pixel cell of the liquid crystal display device 10 of Embodiment 3 will be described with reference to FIG. 18 and FIG. 20.

Pixel cells surrounded by a dot line in FIG. 18 and FIG. 20 are focused.

The gate lines Gate (1), Gate (2), Gate (3), and Gate (4) are connected to each of the gate electrodes of the respective pixels. In the drawings, the gate electrodes of the TFTs of the pixels R1 and B1 are connected to the gate line Gate (1), the gate electrode of the TFT of the pixel G1 is connected to the gate line Gate (2), the gate electrode of the TFT of the pixel G2 is connected to the gate line Gate (3), and the gate electrodes of the TFTs of the pixels R2 and B2 are connected to the gate line Gate (4).

The data line Data (1) is connected to the pixels R1, G1, R2, and G2, and the data line Data (2) is connected to the pixels B1 and B2.

### (2) Drive Method at N^{th} Frame

Referring now to the timing chart in FIG. 19, the drive method of Embodiment 3 at the N^{th} frame will be described.

First of all, when the gate line Gate (1) becomes the H level, the H level is supplied to the gate electrodes of the TFTs of the pixels R1 and B1, whereby the source electrodes and the drain electrodes of the TFTs of the pixels R1 and B1 are brought into the conducting state. Negative signal potentials of a previous stage are supplied to the pixel electrodes of the pixels R1 and B1 from the data lines Data (1) and Data (2) via the source electrodes. Then, positive signal potentials are applied to the pixel electrodes of the pixels R1 and B1 from the data lines Data (1) and Data (2) via the source electrodes.

Subsequently, when the gate line Gate (2) becomes the H level, the H level is supplied to the gate electrode of the TFT of the pixel G1, whereby the source electrode and the drain electrode of the TFT of the pixel G1 are brought into the conducting state, and the positive signal potential applied to the pixel electrode of the pixel R1 is applied from the data line Data (1) to the pixel electrode of the pixel G1.

Subsequently, when the gate line Gate (1) becomes the L level, the L level is supplied to the gate electrodes of the TFTs of the pixels R1 and B1, whereby the source electrodes and the drain electrodes of the TFTs of the pixels R1 and B1 are brought into the insulated state, and the pixels R1 and B1 retain the positive potentials. In contrast, a positive signal potential is applied to the pixel G1, the source electrode and the drain electrode of which are in the conducting state, from the data line Data (1).

Subsequently, when the gate line Gate (2) becomes the L level, the L level is supplied to the gate electrode of the TFT of the pixel G1, whereby the source electrode and the drain electrode of the TFT of the pixel G1 are brought into the insulated state, and the pixel G1 retains the positive potential.

Subsequently, when the gate line Gate (3) becomes the H level, the H level is supplied to the gate electrode of the TFT of the pixel G2, whereby the source electrode and the drain electrode of the TFT of the pixel G2 are brought into the conducting state. A positive signal potential of a previous stage is supplied to the pixel electrode of the pixel G2 from the data line Data (1) via the source electrode. Then, a negative signal potential is applied to the pixel electrode of the pixel G2 from the data line Data (1) via the source electrode.

Subsequently, when the gate line Gate (4) becomes the H level, the H level is supplied to the gate electrodes of the TFTs of the pixels R2 and B2, whereby the source electrodes and the drain electrodes of the TFTs of the pixels R2 and B2 are brought into the conducting state. Negative signal potential applied to the pixel electrode of the pixel G2 is applied to the pixel electrodes of the pixels R2 and B2.

Subsequently, when the gate line Gate (3) becomes the L level, the L level is supplied to the gate electrode of the TFT of the pixel G2, whereby the source electrode and the drain electrode of the TFT of the pixel G2 are brought into the insulated state, and the pixel G2 retains the negative potential. In contrast, negative signal potentials are applied to the pixels R2 and B2, the source electrodes and the drain electrodes of which are in the conducting state, from the data lines Data (1) and Data (2).

Subsequently, when the gate line Gate (4) becomes the L level, the L level is supplied to the gate electrodes of the TFTs of the pixels R2 an B2, whereby the source electrodes and the drain electrodes of the TFTs of the pixel R2 and B2 are brought into the insulated state, and the pixels R2 and B2 retain the negative potentials.

In this configuration, at the pixel electrodes of the pixels R1 and B1, a data signal having a potential of a polarity opposite to the desired potential is written in the pre-charge period, and then a desired data signal is written in the writing period at the N^{th} frame illustrated in FIG. 18 (in the drawing, it is expressed as “NG”). In contrast, at the pixel electrode of the pixel G1, a data signal having the same polarity as the desired potential is written in the pre-charge period, and then a desired data signal is written in the writing period (in the drawing, it is expressed as “OK”).

In the same manner, at the pixel electrode of the pixel G2, a data signal having a potential of a polarity opposite to the desired potential is written in the pre-charge period, and then a desired data signal is written in the writing period illustrated in FIG. 18 (in the drawing, it is expressed as “NG”). In contrast, at the pixel electrodes of the pixels R2 and B2, a data signal having the same polarity as the desired potential is written in the pre-charge period, and then a desired data signal is written in the writing period (in the drawing, it is expressed as “OK”).

Therefore, the pixels against charging (NG pixels) at the N^{th} frame are the pixels R1, B1, and G2.

### (3) Drive Method at (N+1)^{th} Frame

Referring now to the timing chart in FIG. 21, the drive method of Embodiment 3 at the (N+1)^{th} frame will be described.

First of all, when the gate line Gate (2) becomes the H level, the H level is supplied to the gate electrode of the TFT of the pixel G1, whereby the source electrode and the drain electrode of the TFT of the pixel G1 are brought into the conducting state. A positive signal potential of a previous stage is supplied to the pixel electrode of the pixel G1 from the data line Data (1) via the source electrode. Then, a negative signal potential is applied to the pixel electrode of the pixel G1 from the data line Data (1) via the source electrode.

Subsequently, when the gate line Gate (1) becomes the H level, the H level is supplied to the gate electrodes of the TFTs of the pixels R1 and B1, whereby the source electrodes and the drain electrodes of the TFTs of the pixels R1 and B1 are brought into the conducting state, and the negative signal potential applied to the pixel electrode of the pixel G1 is applied to the pixel electrodes of the pixels R1 and B1.

Subsequently, when the gate line Gate (2) becomes the L level, the L level is supplied to the gate electrode of the TFT of the pixel G1, whereby the source electrode and the drain electrode of the TFT of the pixel G1 are brought into the insulated state, and the pixel G1 retains the negative potential. In contrast, negative signal potentials are applied to the pixels R1 and B1, the source electrodes and the drain electrodes of which are in the conducting state, from the data lines Data (1) and Data (2).

Subsequently, when the gate line Gate (1) becomes the L level, the L level is supplied to the gate electrodes of the TFTs of the pixels R1 and B1, whereby the source electrodes and the drain electrodes of the TFTs of the pixels R1 and B1 are brought into the insulated state, and the pixels R1 and B1 retain the negative potentials.

Subsequently, when the gate line Gate (4) becomes the H level, the H level is supplied to the gate electrodes of the TFTs of the pixels R2 and B2, whereby the source electrodes and the drain electrodes of the TFTs of the pixels R2 and B2 are brought into the insulated state. Negative signal potentials of a previous stage are supplied to the pixel electrodes of the pixels R2 and B2 from the data lines Data (1) and Data (2) via the source electrodes. Then, a positive signal potential is applied to the pixel electrodes of the pixel R2 and B2 from the data lines Data (1) and Data (2) via the source electrodes.

Subsequently, when the gate line Gate (3) becomes the H level, the H level is supplied to the gate electrode of the TFT of the pixel G2, whereby the source electrode and the drain electrode of the TFT of the pixel G2 are brought into the conducting state. Positive signal potentials applied to the pixel electrodes of the pixels R2 and B2 are applied to the pixel electrode of the pixel G2.

Subsequently, when the gate line Gate (4) becomes the L level, the L level is supplied to the gate electrodes of the TFTs of the pixels R2 and B2, whereby the source electrodes and the drain electrodes of the TFTs of the pixels R2 and B2 are brought into the insulated state, and the pixels R2 and B2 retain the positive potentials. In contrast, a positive signal potential is applied to the pixel G2, the source electrode and the drain electrode of which are in the conducting state, from the data line Data (1).

Subsequently, when the gate line Gate (3) becomes the L level, the L level is supplied to the gate electrode of the TFT of the pixel G2, whereby the source electrode and the drain electrode of the TFT of the pixel G2 are brought into the insulated state, and the pixel G2 retains the positive potential.

In this configuration, at the pixel electrodes of the pixel G1, a data signal having a potential of a polarity opposite to the desired potential is written in the pre-charge period, and then a desired data signal is written in the writing period at the (N+1)^{th} frame illustrated in FIG. 20 (in the drawing, it is expressed as “NG”). In contrast, at the pixel electrodes of the pixels R1 and B1, a data signal having the same polarity as the desired potential is written in the pre-charge period, and then a desired data signal is written in the writing period (in the drawing, it is expressed as “OK”).

In the same manner, at the pixel electrodes of the pixels R2 and B2, a data signal having a potential of a polarity opposite to the desired potential is written in the pre-charge period, and then a desired data signal is written in the writing period illustrated in FIG. 20 (in the drawing, it is expressed as “NG”). In contrast, at the pixel electrode of the pixel G2, a data signal having the same polarity as the desired potential is written in the pre-charge period, and then a desired data signal is written in the writing period (in the drawing, it is expressed as “OK”).

Therefore, the pixels against charging (NG pixels) at the (N+1)^{th} frame are the pixels G1 R2, and B2.

### (3) Advantages

According to Embodiment 3, by changing the connection between the gate lines and the pixels at pixels of a row c and a row c+1, the pixels against charging and the pixels which are not against charging are equalized in a plane even in the same frame, so that the luminance difference caused by the charge difference between the respective pixels is averaged temporarily and spatially, so that the image display is achieved without impairing the image quality.

In the related art, when wiring of the In-Cell touch panel or the like is performed, there are a requirement of wiring on a separate layer and a probability of a reduction of the aperture ratio. However, with the configuration of the data-sharing type, the number of the data lines can be reduced. Therefore, it is not necessary to perform wiring on a separate layer for wiring of the touch panel, and a reduction of the aperture ratio is reduced.

### Embodiment 4

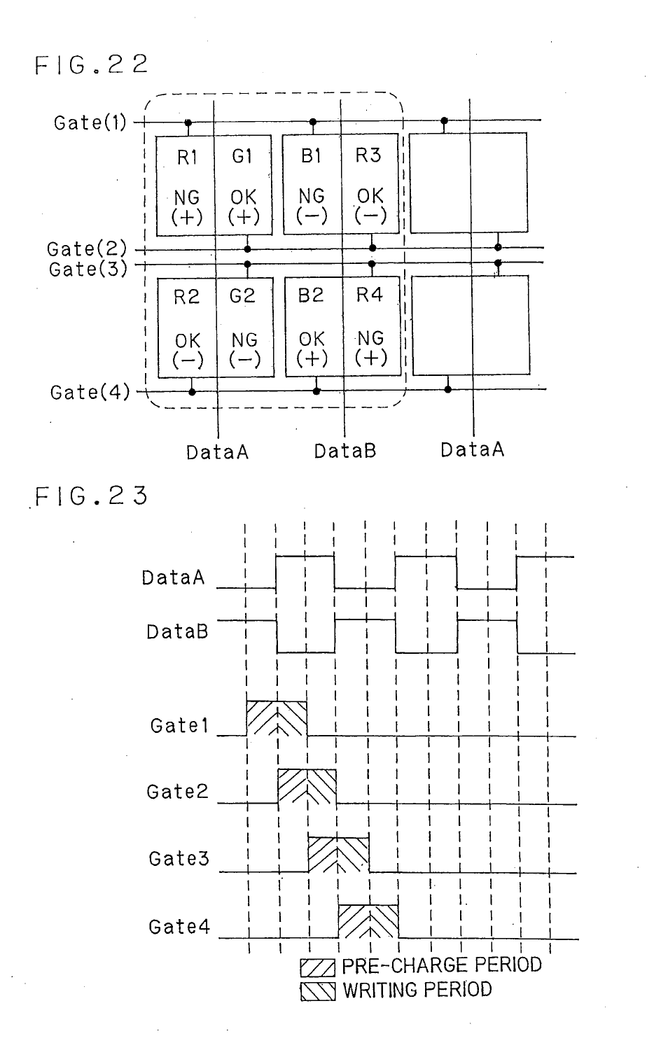

Referring now to FIG. 22 to FIG. 25, the liquid crystal display device 10 of Embodiment 4 will be described.

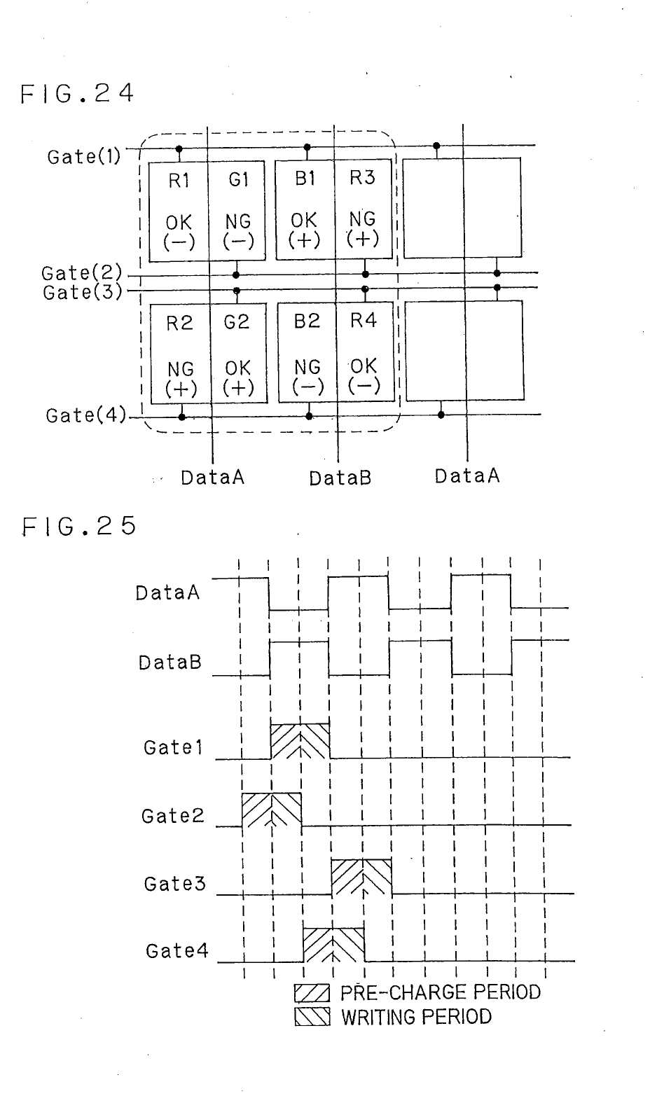

The H line inversion drive method has been described in the respective embodiments described above. In Embodiment 4, instead, the gate line multi-drive and the gate line connection change are performed in a 2HIV two pixel dots inversion drive method of the data-sharing type liquid crystal display device 10. FIG. 22 illustrates a state of charging the pixels at the N^{th} frame of Embodiment 4, FIG. 23 illustrates a timing chart, FIG. 24 illustrates a state of charging the pixels at the (N+1)^{th} frame, and FIG. 25 illustrates a timing chart.

The configuration of the pixel cell in Embodiment 4 is the same as that in Embodiment 3 as illustrated in FIG. 22 and FIG. 24.

The drive method of Embodiment 4 inverts the phases of a data signal Data A and a data signal Data B as illustrated in FIG. 23 and FIG. 25.

### Embodiment 5

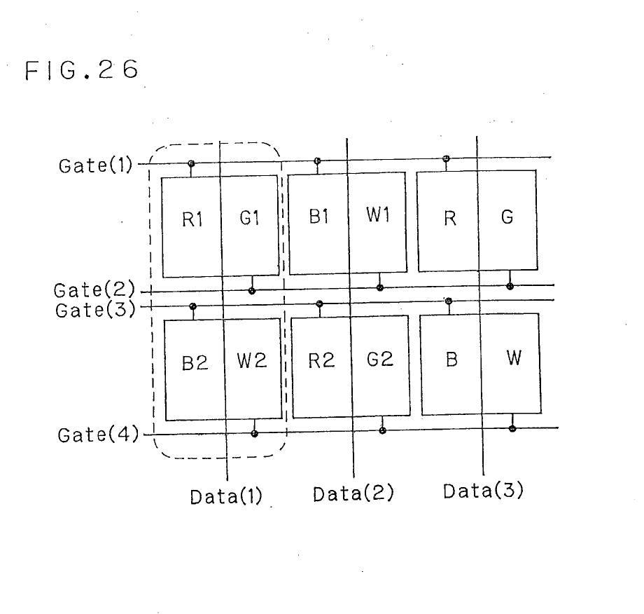

Subsequently, the data-sharing type liquid crystal display device 10 in which Pentile pixels are used will be described with reference to Embodiment 5 to Embodiment 8 on the basis of in FIG. 26 to FIG. 36. In other words, in Embodiments 5 to 8, red (R), green (G), blue (B), and white (W) Pentile pixels are used instead of RGB three-color pixels.

Embodiment 5 is an example of the data-sharing type liquid crystal display device 10 in which Pentile pixels are used, and corresponds to Embodiment 1.

FIG. 26 is a configuration drawing of the Pentile pixels of Embodiment 5. As illustrated by a dot line in the drawing, the gate electrodes of the TFTs of the pixels R1 and B1 are connected to the gate line Gate (1), the gate electrodes of the TFTs of the pixels G1 and W1 are connected to the gate line Gate (2), the gate electrodes of the TFTs of the pixels R2 and B2 are connected to the gate line Gate (3), and the gate electrodes of the TFTs of the pixels W2 and G2 are connected to the gate line Gate (4).

The pixels R1 and G1 and the pixels B2 and W2 are connected to a c^{th} data line, and the pixels B1 and W1 and the pixels R2 and G2 are connected to a (c+1)^{th} data line.

The drive method of Embodiment 5 is the same as that of Embodiment 1. However, the pixel R3 of Embodiment 1 is replaced by the pixel W1 and the pixel R4 is replaced by the pixel G2.

In this configuration, although an adjustment of the aperture ratio is required in a combination of the three-pixels and the data-sharing type of the related art, the adjustment of the aperture ratio is not required by the combination of the data-sharing type with the Pentile pixel as in Embodiment 5.

According to Embodiment 5, the luminance difference caused by the charging difference of the data signals with respect to the respective pixels may be averaged temporarily and spatially, and the image display without impairing the image quality such as uneven display or lowering of the luminance is achieved.

In the related art, when wiring of the In-Cell touch panel or the like is performed, there are a requirement of wiring on a separate layer and a probability of a reduction of the aperture ratio.

### Embodiment 6

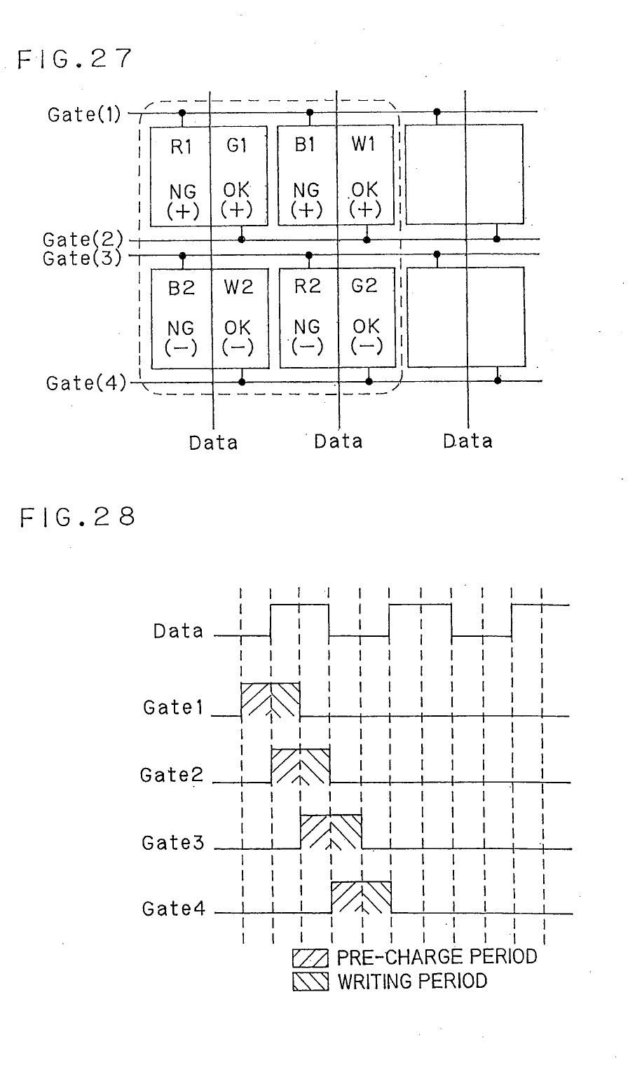

Referring now to FIG. 27 to FIG. 30, the liquid crystal display device 10 of Embodiment 6 will be described. Embodiment 6 relates to the data-sharing type liquid crystal display device 10 in which the Pentile pixels are used, is an example in which the H line inversion drive method and the gate line multi-drive are combined, and corresponds to Embodiment 2.

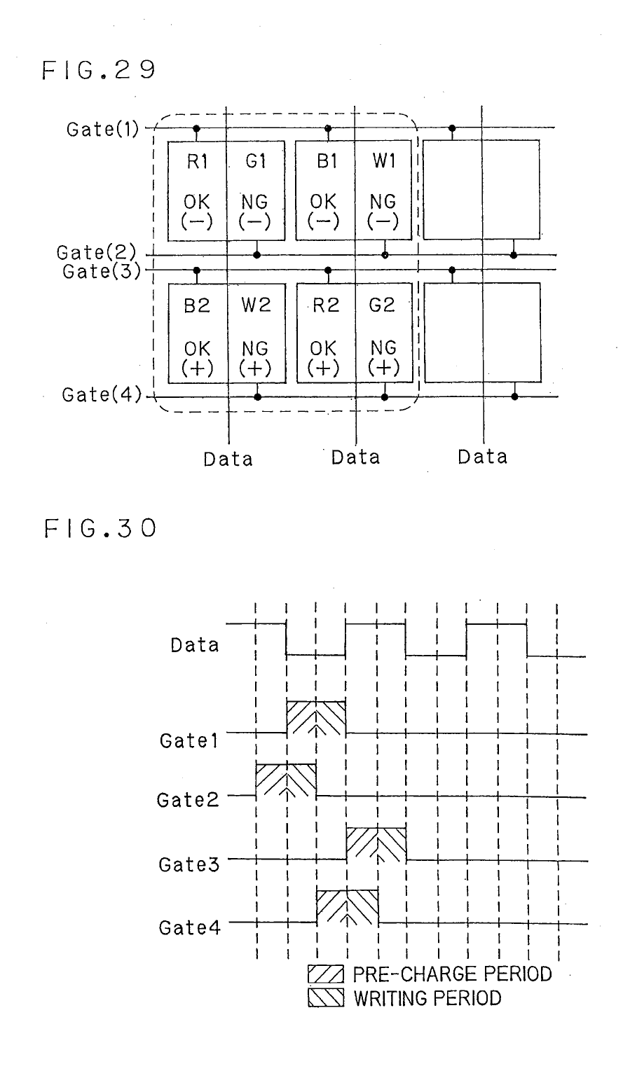

FIG. 27 illustrates a state of charging the pixels at the N^{th} frame, FIG. 28 illustrates a timing chart, FIG. 29 illustrates a state of charging the pixels at the (N+1) t¹¹ frame, and FIG. 30 illustrates a timing chart.

The configuration of the Pentile pixels in Embodiment 6 is the same as that in Embodiment 5 as illustrated in FIG. 27 and FIG. 29.

As illustrated in FIG. 28 and FIG. 30, the drive method of Embodiment 6 is the same as that of Embodiment 2. However, the pixel R3 of Embodiment 2 is replaced by the pixel W1 and the pixel R4 is replaced by the pixel G2.

According to Embodiment 6, the luminance difference caused by the charging difference of the data signals with respect to the respective pixels may be averaged temporarily and spatially, and the image display without impairing the image quality such as uneven display or lowering of the luminance is achieved.

### Embodiment 7

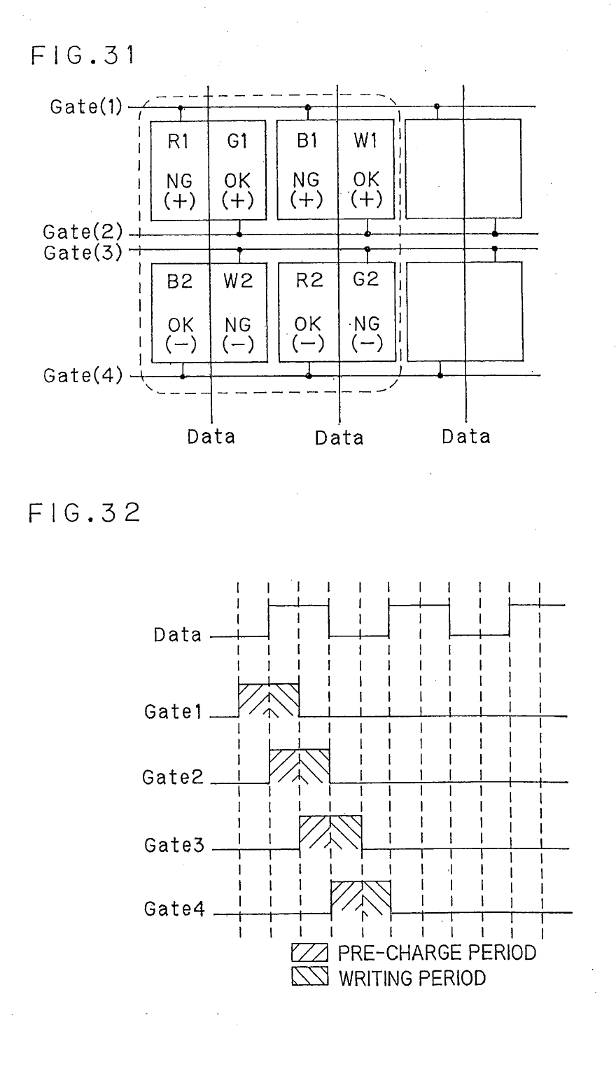

Referring now to FIG. 31 to FIG. 34, the liquid crystal display device 10 of Embodiment 7 will be described. Embodiment 7 relates to the data-sharing type liquid crystal display device 10 in which the Pentile pixels are used, is an example in which the H line inversion drive method and the gate line connection change of the gate line multi-drive are combined, and corresponds to Embodiment 3.

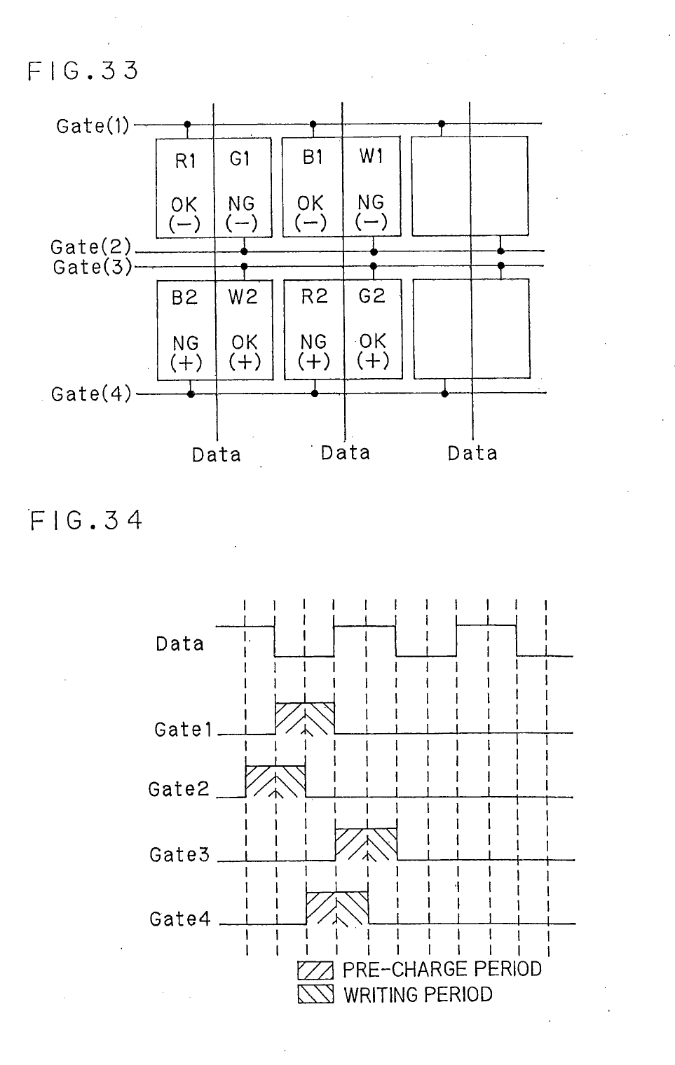

FIG. 31 illustrates a state of charging the pixels at the N^{th} frame, FIG. 32 is a timing chart, FIG. 33 is a state of charging the pixels at the (N+1)^{th} frame, and FIG. 34 is a timing chart.

FIG. 31 and FIG. 33 are configuration drawing of the Pentile pixels corresponding to Embodiment 3. As illustrated by a dot line in the drawing, the gate electrodes of the TFTs of the pixels R1 and B1 are connected to the gate line Gate (1), the gate electrodes of the TFTs of the pixels G1 and W1 are connected to the gate line Gate (2), the gate electrodes of the TFTs of the pixels W2 and G2 are connected to the gate line Gate (3), and the gate electrodes of the TFTs of the pixels B2 and R2 are connected to the gate line Gate (4).

The pixels R1 and G1 and the pixels B2 and W2 are connected to the c^{th} data line, and the pixels B1 and W1 and the pixels R2 and G2 are connected to the (c+1)^{th} data line.

As illustrated in FIG. 32 and FIG. 34, the drive method of Embodiment 7 is the same as that of Embodiment 3. However, the pixel R3 of Embodiment 2 is replaced by the pixel W1 and the pixel R4 is replaced by the pixel G2.

According to Embodiment 7, the luminance difference caused by the charging difference of the data signals with respect to the respective pixels may be averaged temporarily and spatially, and the image display without impairing the image quality such as uneven display or lowering of the luminance is achieved.

In addition, by a change of the connecting method for the gate lines and the pixels, the pixels against charging and the pixels which are not against charging are dispersed uniformly in a plane even in the same frame.

### Embodiment 8

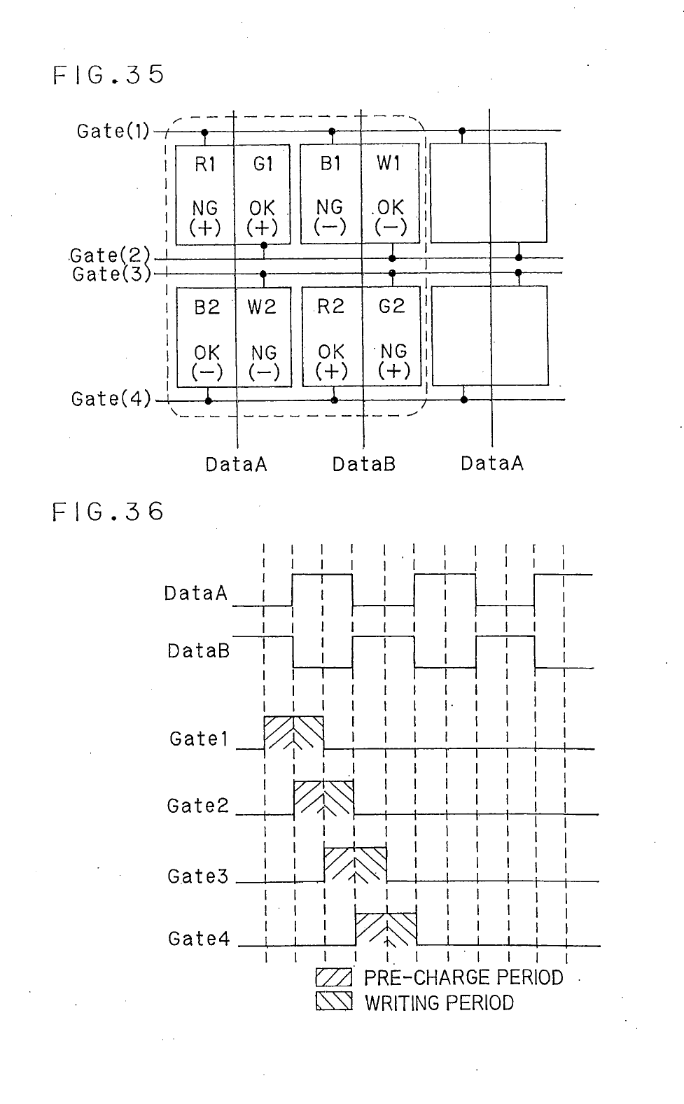

Referring now to FIG. 35 to FIG. 38, the liquid crystal display device 10 of Embodiment 8 will be described. Embodiment 8 relates to the data-sharing type liquid crystal display device 10 in which the Pentile pixels are used, is an example in which the 2-pixel dot inversion drive method and the gate line connection change of the gate line multi-drive are combined, and corresponds to Embodiment 4.

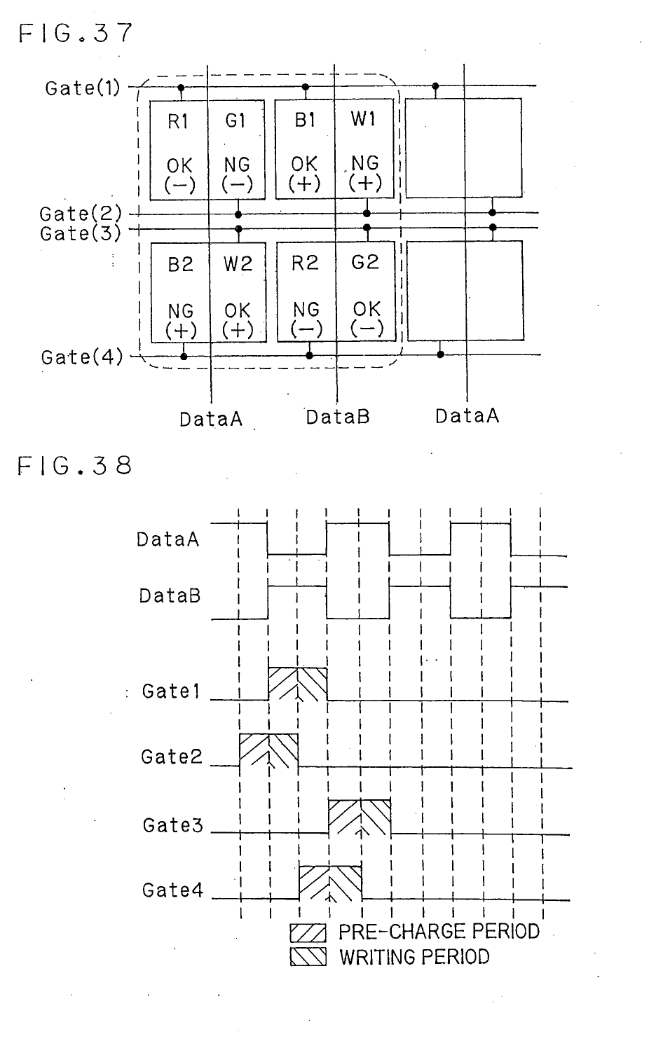

FIG. 35 illustrates a state of charging the pixels at the N^{th} frame, FIG. 36 illustrates a timing chart, FIG. 37 illustrates a state of charging the pixels at the (N+1)^{th} frame, and FIG. 38 illustrates a timing chart.

The configuration of the Pentile pixels in Embodiment 8 is the same as that in Embodiment 7 as illustrated in FIG. 35 and FIG. 37.

As illustrated in FIG. 36 and FIG. 38, the drive method of Embodiment 8 is the same as that of Embodiment 4. However, the pixel R3 of Embodiment 2 is replaced by the pixel W1 and the pixel R4 is replaced by the pixel G2.

According to Embodiment 8, the luminance difference caused by the charging difference of the data signals with respect to the respective pixels may be averaged temporarily and spatially, and the image display without impairing the image quality such as uneven display or lowering of the luminance is achieved.

In addition, by a change of the connecting method for the gate lines and the pixels, the pixels against charging and the pixels which are not against charging are dispersed uniformly in a plane even in the same frame.

### Modification

Although the liquid crystal display device 10 has been used for description of the respective embodiments, even though this disclosure is applied to an organic EL display device, the same advantages as the embodiments described above are achieved.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. An image display device comprising:
an image display unit on which (C×2D) pixels are arrayed in a matrix pattern;
D data lines configured to supply data signals to the pixels;
2C gate lines arranged so as to intersect the data lines and configured to supply gate signals to the pixels;
a data line driver circuit configured to supply data signals to the data lines;
a first gate line driver circuit configured to supply gate signals to a c^{th} gate line (where c is an odd number and a relation 1≦c<2C−1 is satisfied); and
a second gate line driver circuit configured to supply gate signals to a (c+1)^{th} gate line, wherein
the data lines are connected to the pixels arranged on both sides of the data lines respectively,
the c^{th} gate line and the (c+1)^{th} gate line are connected respectively to the pixels arrayed between the c^{th} gate line and the (c+1)^{th} gate line alternately, and
the first gate line driver circuit and the second gate line driver circuit
(1) supplies the gate signals to the c^{th} gate line and the (c+1)^{th} gate line in this order when displaying an image at the N^{th} frame (N≧1), and
(2) supplies the gate signals to the (c+1)^{th} frame and the c^{th} gate line in this order when displaying an image at a (N+1)^{th} frame.

2. An image display device comprising:
an image display unit on which (C×2D) pixels are arrayed in a matrix pattern;
a D data lines configured to supply data signals to the pixels;
2C gate lines arranged so as to intersect the data lines and configured to supply gate signals to the pixels;
data line driver circuit configured to supply data signals to the data lines;
a first gate line driver circuit configured to supply gate signals to the c^{th} gate line (where c is an odd number and a relation 1≦c<2C−1 is satisfied);
a second gate line driver circuit configured to supply gate signals to (c+1)^{th} gate lines; and
a main control unit, wherein
the data lines are connected to the pixels arranged on both sides of the data lines respectively,
the c^{th} gate line and the (c+1)^{th} gate line are connected respectively to the pixels arrayed between the c^{th} gate line and the (c+1)^{th} gate line alternately,
the first gate line driver circuit and the second gate line driver circuit
(1) supplies the gate signals to the c^{th} gate line and the (c+1)^{th} gate line in this order when displaying an image at the N^{th} frame (where N≧1),
(2) supplies the gate signals to the (c+1)^{th} frame and the c^{th} gate line in this order when displaying an image at the (N+1)^{th} frame, and
the main control unit
supplies the start pulses to the first gate line driver circuit and the second gate line driver circuit in this order when displaying the image at the N^{th} frame, and
supplies start pulses to the second gate line driver circuit and the first gate line driver circuit in this order when displaying the image at the (N+1)^{th} frame.

3. The image display device according to claim 1, wherein
a c+2^{th} gate line (where 1<(c+2)<2C−1) is connected to the pixels in the same row as the c^{th} gate line, and
a c+3^{th} gate line is connected to the pixels in the same row as the (c+1)^{th} gate line.

4. The image display device according to claim 1, wherein
a c+2^{th} gate line (where 1<(c+2)<2C−1) is connected to the pixels in the same row as the (c+1)^{th} gate line, and
a c+3^{th}′ gate line is connected to the pixels in the same row as the c^{th} gate line.

5. The image display device according to claim 1, wherein
one pixel cell includes pixels in three colors including a red pixel, a green pixel, and a blue pixel.

6. The image display device according to claim 1, wherein
one pixel cell includes Pentile pixels including a red pixel, a green pixel, a blue pixel, and a white pixel.

7. The image display device according to claim 1, wherein
the image display device is a liquid crystal display device or an organic EL display device.

8. A driving method for an image display device comprising:
an image display unit on which (C×2D) pixels are arrayed in a matrix pattern;
D data lines configured to supply data signals to the pixels;
2C gate lines arranged so as to intersect the data lines and configured to supply gate signals to the pixels;
a data line driver circuit configured to supply data signals to the data lines;
a first gate line driver circuit configured to supply gate signals to a c^{th} gate line (where c is an odd number and a relation 1<c<2C−1 is satisfied); and
a second gate line driver circuit configured to supply gate signals to a (c+1)^{th} gate lines, wherein
the data lines are connected to the pixels arranged on both sides of the data lines respectively,
the c^{th} gate line and the (c+1)^{th} gate line are connected respectively to the pixels arrayed between the c^{th} gate line and the (c+1)^{th} gate line alternately, and
the first gate line driver circuit and the second gate line driver circuit
(1) supplies the gate signals to the c^{th} gate line and the (c+1)^{th} gate line in this order when displaying an image at a N^{th} frame (N≧1), and
(2) supplies the gate signals to the (c+1)^{th} frame and the c^{th} gate line in this order when displaying an image at a (N+1)^{th} frame.

9. A driving method for an image display device comprising:
an image display unit on which (C×2D) pixels are arrayed in a matrix pattern;
D data lines configured to supply data signals to the pixels;
2C gate lines arranged so as to intersect the data lines and configured to supply gate signals to the pixels;
a data line driver circuit configured to supply data signals to the data lines;
a first gate line driver circuit configured to supply gate signals to a c^{th} gate line (where c is an odd number and a relation 1<c<2C−1 is satisfied);
a second gate line driver circuit configured to supply gate signals to a (c+1)^{th} gate lines; and
a main control unit, wherein
the data lines are connected to the pixels arranged on both sides of the data lines respectively,
the c^{th} gate line and the (c+1)^{th} gate line are connected respectively to the pixels arrayed between the c^{th} gate line and the (c+1)^{th} gate line alternately,
the first gate line driver circuit and the second gate line driver circuit
(1) supplies the gate signals to the c^{th} gate line and the (c+1)^{th} gate line in this order when displaying an image at a N^{th} frame (N≧1),
(2) supplies the gate signals to the (c+1)^{th} frame and the c^{th} gate line in this order when displaying an image at a (N+1)^{th} frame, and
the main control unit
supplies start pulses to the first gate line driver circuit and the second gate line driver circuit in this order when displaying the image at the N^{th} frame, and
supplies the start pulses to the second gate line driver circuit and the first gate line driver circuit in this order when displaying the image at the (N+1)^{th} frame.

10. The driving method for an image display device according to claim 8, wherein
the image display device displays an image on the basis of a H-line inversion driving method.

11. The driving method for an image display device according to claim 8, wherein
the image display device displays an image on the basis of a two pixel dot inversion driving method.

12. The image display device according to claim 2, wherein
a c+2^{th} gate line (where 1<(c+2)<2C−1) is connected to the pixels in the same row as the c^{th} gate line, and
a c+3^{th} gate line is connected to the pixels in the same row as the (c+1)^{th} gate line.

13. The image display device according to claim 2, wherein
a c+2^{U} gate line (where 1<(c+2)<2C−1) is connected to the pixels in the same row as the (c+1)^{th} gate line, and
a c+3^{th} gate line is connected to the pixels in the same row as the c^{th} gate line.

14. The image display device according to claim 2, wherein
one pixel cell includes pixels in three colors including a red pixel, a green pixel, and a blue pixel.

15. The image display device according to claim 2, wherein
one pixel cell includes Pentile pixels including a red pixel, a green pixel, a blue pixel, and a white pixel.

16. The image display device according to claim 2, wherein
the image display device is a liquid crystal display device or an organic EL display device.

17. The driving method for an image display device according to claim 9, wherein
the image display device displays an image on the basis of a H-line inversion driving method.

18. The driving method for an image display device according to claim 9, wherein
the image display device displays an image on the basis of a two pixel dot inversion driving method.
